(19) United States
(12) Patent Application Publication
(10) Pub. No.: US 2009/0217926 A1
(43) Pub. Date: Sep. 3, 2009

(54) RESPIRATOR

(75) Inventors: Justin Hine, Wiltshire (GB); Brian Davis, Wiltshire (GB); Marcus Durant, Devon (GB)

Correspondence Address: MCGARRY BAIR PC, 32 Market Ave. SW, SUITE 500, GRAND RAPIDS, MI, 49503, US

(73) Assignee: AVON POLYMER PRODUCTS LIMITED, Wiltshire (GB)

(21) Appl. No.: 12/089,566

(22) PCT Filed: Sep. 28, 2006
(86) PCT No.: PCT/GB06/03612

§ 371 Date: Sep. 17, 2008

(30) Foreign Application Priority Data
Oct. 13, 2005 (GB) 0520835.0

(51) Int. Cl. A62B 23/02; A62B 18/10

(52) U.S. Cl. 128/201.25; 128/206.12; 128/206.15

(57) ABSTRACT

A respirator which has a collapsible air guide (2) and two filter supports (3), the filter supports (3) each having a first end (35)=joined to the first end (35) of the other, and a second end (36) opposite to the first end (35). The air guide (2) is in a collapsed state when second ends (36) of the filter supports (3) are adjacent to one another, and is in a deployed state when the second ends (36) are further apart. The air guide (2) may be located between the filter supports (3) when the second ends (36) of the filter supports (3) are adjacent to each other.

### BACKGROUND OF THE INVENTION

1. Field of the Invention

This invention relates to respirators, in particular respirators intended for single emergency use.

2. Summary of the Prior Art

Filtration masks have been known for many years and have been developed particularly for use in military conflicts, to provide protection for e.g. soldiers against chemical and biological hazards. These masks usually employ a rubber mask section which covers the wearers face, and acts as a housing for air filters. These masks must seal effectively around the face of the wearer, to ensure that no hazardous vapours can enter the wearer's respiratory system by routes other than via the air filters. These masks are often cumbersome, expensive, and must be sized to the particular wearer, in order to provide an effective seal around the periphery of the wearer's face.

Other more simple masks are known, such as surgical masks that are used by doctors and surgeons, in order to protect patients from germs contained in their breath. These masks cover only the wearer's nose and mouth. They may be formed entirely from filtration material. Similar masks are used by woodworkers and construction workers etc. to prevent dust particles entering their respiratory systems. It is not essential that these masks provide effective seals about the nose and mouth of the wearer.

The rising threat of terrorist attacks, in particular terrorist attacks involving chemical, biological, radiological and nuclear (CBRN) weapons, have increased the need for respirators that can be carried easily by the general public, for emergency use, and that provide an effective seal about the head of the wearer. Ideally these respirators are compact and lightweight, so that they may be stored or carried conveniently by a person, ready for use at any time. Furthermore, it is desirable that these respirators can be produced cheaply, for sale to a wide market.

In an attempt to meet these demands, respirators called ‘escape hoods’ have been developed in recent years. These are designed to assist escape from CBRN hazards, and are not intended for prolonged or repeated use. These respirators need to provide a wearer with protection for only 15 minutes or so, preferably 20 minutes, to allow escape from a contaminated area. They generally comprise an oro-nasal mask, for fitting over the wearer's nose and mouth, and a hood (with neckdam) for fitting over the wearer's head. Air filters are connected to the oro-nasal mask. The hood may serve to protect the wearer's eyes and other facial, head and neck features, from hazardous chemicals.

International patent application no., PCT/GB2004/003744 discloses one such escape hood-type respirator. It comprises a hood and a flexible oro-nasal mask which is capable of recovering its original shape from a collapsed state. Air filters are fitted to two hinged support elements attached to the mask. Before use, the oro-nasal mask is in a collapsed state. The support elements are folded outwardly so that the free ends (opposite to the hinged ends) of the support elements are far apart. The collapsed oro-nasal mask lies in a dead space between the two support elements. Thus, this respirator takes a flattened, elongated shape in order that it can be stored ready for use. However, this shape is not ideal for storage on e.g. a utility belt worn by a person, as it can hinder the person's movement. Furthermore, the oro-nasal mask is not well protected with this configuration, and may therefore be vulnerable to damage e.g. during transit.

### SUMMARY OF THE INVENTION

Thus, at its most general, the present invention provides a respirator with one or more filter support elements which enclose a collapsed air guide (e.g. an oro-nasal mask), when in a storage position.

Thus, according to the present invention, there may be provided:

a respirator, including a collapsible air guide and two filter supports,

each filter support having a first end and a second end opposite to the first end,

the first ends of the filter supports being joined together, the second ends being free ends,

wherein the filter supports are relatively movable from a first position, in which the second ends are adjacent to one another and the air guide is in a collapsed state, to a second position, in which the second ends are further apart than in the first position and the air guide is in a deployed state.

When the filter supports are in the first position, the respirator may be in a state appropriate for storage thereof. When the filter is in the second position, the respirator may be in a state appropriate for use thereof.

Preferably, the air guide is an oro-nasal mask, i.e. a mask which covers the mouth and nostrils.

Preferably, when the air guide is in its deployed state, it takes its natural shape. The filter supports may be fixed to opposing outer sides of the air guide such that, when the filter supports are in the first position, they press these outer sides together, thus forcing the air guide into a collapsed state, rather than allowing it to take its natural shape. In view of this, preferably the air guide is resiliently deformable so that it may recover its natural shape automatically when the filter supports are moved from the first position (in which it is in the collapsed state) to the second position, essentially by the air guide springing into its natural shape. This resilient deformability may be provided by the air guide being of silicone or polyisoprene elastomer. By recovering its shape automatically, no user input may be required to deploy the air guide, other than moving of the filters supports to the second position. This makes deployment of the respirator easier and quicker for the user, which may be vital when it is needed in an emergency situation.

Preferably, the joining of the first ends of the filter supports is via a central support. The central support spaces the first ends of the filter supports apart. By spacing these ends of the filter supports apart, when the free ends of the filter supports are adjacent, a space is maintained between the filter supports. The collapsed air guide may be located in this space. Effectively, the filter supports and central support may provide, in combination, three walls of an enclosure that surrounds the air guide.

The first end of one filter support may be hinged to an edge of the central support, and the first end of the other filter support may be hinged to the opposite edge of the central support. Thus, each filter support may be pivotable from the first position to the second position about a respective edge of the central support. Preferably, the central support is a rectangular plate with the first ends of the filter supports hinged to the two opposite longest edges of the plate. Preferably hinging is provided by living hinges. A living hinge consists of a thin section of material, usually plastic, that is very flexible; this flexibility allows the living hinge to connect parts together so that they relatively rotate about the living hinge. Thus, living hinges which extend continuously along opposite edges of the central support may be provided. As an alternative, a plurality of smaller living hinges, forming a set, may be provided along each of these edges of the central support. By using living hinges, manufacture of the filter supports and central support may be easier, since e.g. they can be manufactured together as a single piece.

A filter is preferably mounted to each filter support. The filter supports may provide sockets within which the filters are mounted. Preferably, the filter supports are plastic (polyurethane) housings that are ultrasonically welded. Preferably, each filter comprises two types of filtration media such as a high efficiency particulate filter element (HEPA) that is capable of providing P3 class level of protection and an activated charcoal filter element for removing vapour from air. The activated charcoal filter element may provide a backing to the HEPA element.

Preferably, an air path is provided from the filters to the air guide via respective openings in the filter supports. Preferably, an inhale valve is provided in each of these openings. Preferably, the inhale valves each comprise a disc retained by a central stalk. Preferably the disc is 2.5 cm in diameter and preferably the disc is of polyisoprene or silicone. The inhale valves prevent air being exhaled to the atmosphere through the filters.

Preferably, an air path is provided from the air guide to the atmosphere external to the respirator through one or more openings in the central support. Preferably an exhale valve is provided in each of these openings. Preferably, the exhale valves are of polyisoprene or silicone. Preferably, two or more exhale valves are positioned one above the other on the central support. Preferably, the exhale valves each comprise a disc retained by a central stalk. The exhale valves prevent air being inhaled from the atmosphere via the openings in the central support.

Preferably, the central support has an exhale valve cover on its front surface. In this description, the term “front” is intended to mean the side of a component part of the respirator which, in use, faces away from the wearer's head and the term “rear” is intended to mean the side which, in use, faces toward the wearer's head. Also, in this description, the terms “upwardly”, “downwardly”, “above”, “below”, “horizontal” and “vertical” are intended to define relative positioning or the nature of component parts of the respirator during normal use, i.e. when the respirator is worn by a person standing straight with a level head. However, the respirator according to the present invention is not intended to be limited to this or any other orientation.

The exhale valve cover may define a dead space and may serve to channel air that is exhaled through the exhale valves, downwardly. The dead space may safeguard against dynamic leakage from the exhale valves during the respiratory cycle. The exhale valve cover may be a rigid tube section, which, in combination with central support, provides a tubular dead space chamber. Preferably the rigid tube section is approximately 8 cm long.

During the wearer's respiratory cycle, when the wearer inhales, air passes from the external atmosphere, through the filters, then through the inhale valves to the inside of the air guide and then into the wearer's lungs. Then, when the wearer exhales, hot, moist air exhaled by the wearer passes into the air guide, then through the exhale valves and the dead space provided by the exhale valve cover, to the external atmosphere.

The respirator may include a hood for fitting over the head of a wearer. The hood may be connected to the filter supports, air guide, or inhale and/or exhale valves. Preferably, when the support elements are in the first position, the hood is packed in the enclosure provided by the filter supports and the central support. Preferably, the action of opening the hood causes the filter supports to move from the first position to the second position, whereupon the air guide is deployed automatically. Thus, the respirator may be placed in a state ready for use quickly and easily. This is particularly advantageous if the respirator is used in an emergency situation, since immediate use of the respirator may be vital.

Preferably, the hood is of soft, flexible material that can be folded to occupy a small volume. Ideally the hood is of material which provides a barrier against CBRN agents and toxic industrial materials. Preferably the hood is of thin polyurethane that is welded together so that it forms a self supporting structure which may extend from the top of the wearer's head to a region level with the wearer's neck. Ideally, the hood has very high light transmissibility so that a wearer may see through at least a part of the hood clearly. Also, the hood preferably exhibits good resistance to scratching and abrasion.

Preferably, the hood has an elastomeric neck seal. Preferably, the elastomeric neck seal comprises a band of elastomeric material forming a ring. The ring may surround a central hole in the hood, through which a wearer's head may enter the hood, and which seals around the neck of the wearer once the wearer's head enters fully the hood during the donning procedure.

Preferably the hood and neck seal provide appropriate fit and comfort to the 5-95^{th} percentile range of the population. Thus, the circumference of the ring, when positioned about the wearer's neck, may equate to a UK shirt collar size of 15 to 18 inches. To achieve this, preferably, the band can stretch to a length which is at least four times its unstretched length. Preferably, the ring defined by the elastomeric band has a diameter of about 7.5 cm, when the band is unstretched, which can preferably increase to at least 30 cm, upon stretching. By having a neck seal (and hood) that fits the 5-95^{th} percentile range of the population, essentially a one-size fits all respirator may be provided. This may help to reduce manufacturing costs, since it is not necessary to produce respirators of different sizes.

Preferably, in use, the ring of the neck seal fits closely around the wearer's neck in order to prevent ingress of toxic vapour and particulate matter from the external atmosphere. A shield may be provided to protect the neck seal from direct contamination by liquid splashes.

Preferably, the periphery of the air guide seals to the wearer's face. This is desirable to prevent leakage of hot, moist exhaled air into the hood, which could create fogging.

The respirator may be provided with a harness for securing it to the wearer's head. Like the hood, preferably this harness is sized to fit the 5-95^{th} percentile range of the population. To achieve this, the harness may consist of one or more straps, preferably elastic straps, which may have ends fixed adjacent the inhale valves. Preferably, two main straps are provided which extend, in normal use, around the back of the head of the wearer, one that extends below the wearer's ears, the other extending above the wearer's ears. Preferably one or more straps extend between the two main straps in a generally vertical direction. Preferably a strap is also provided which extends over the crown of the wearer's head. The harness may maintain the respirator, and in particular the hood, in a fully supported manner, allowing the wearer to move without risk of the hood slipping.

Preferably, when the respirator is stored, the harness is also packed, with the hood and the air guide, in the enclosure defined by the central support and the filter supports in the first position.

By packing the hood and air guide etc. into the space defined by the central support and the filter supports in the first position, the exterior of the respirator in its storage state may be entirely defined by the filter supports and filters. Thus, the respirator may take a neat and compact state for storage. In the storage state, the central support and filter supports act as shields for the hood and air guide etc., protecting them from damage e.g. during transit of the respirator. Preferably, the respirator in this storage state may be carried on a utility belt of the user, or stored in close proximity to the user (e.g. in a glove compartment of a car).

Since the respirator according to this invention is generally intended for single use in an emergency situation, it is not considered necessary that the hood and air guide etc. should be repackable into the enclosure defined by the central support and the filter supports in the first position, after use. Nevertheless, it is understood that a multi-use respirator could be designed using the same principles of storing the collapsed air guide and hood etc. in an enclosure provided by filter supports, as described herein.

Preferably, when in the storage state, the respirator is placed in external packaging which may be easily removed when the respirator is to be used. Preferably, the external packaging is shower-proof. Preferably the external packaging is inconspicuous, e.g. is black with no external markings.

### BRIEF DESCRIPTION OF THE DRAWINGS

Examples embodying the present invention are now described with reference to the accompanying drawings, in which:

FIG. 1 is an exploded view of a respirator according to a first embodiment of the present invention;

FIG. 2 is a front view of the respirator of FIG. 1, with the oro-nasal mask in a deployed state;

FIG. 3 is a back view of the respirator of FIG. 1, with the oro-nasal mask in a deployed state;

FIG. 4 is a top view of the respirator of FIG. 1, with the oro-nasal mask in a storage position;

FIG. 5 is a top view of the respirator of FIG. 1, with the oro-nasal mask in a deployed state;

FIG. 6 is a transparent oblique view of a respirator, including a hood and a harness, according to a second embodiment of the present invention;

FIG. 7 shows the hood only of the respirator of FIG. 6;

FIG. 8 shows the harness only of the respirator of FIG. 6; and

FIG. 9 shows the hood and harness only of the respirator of FIG. 6

### DETAILED DESCRIPTION

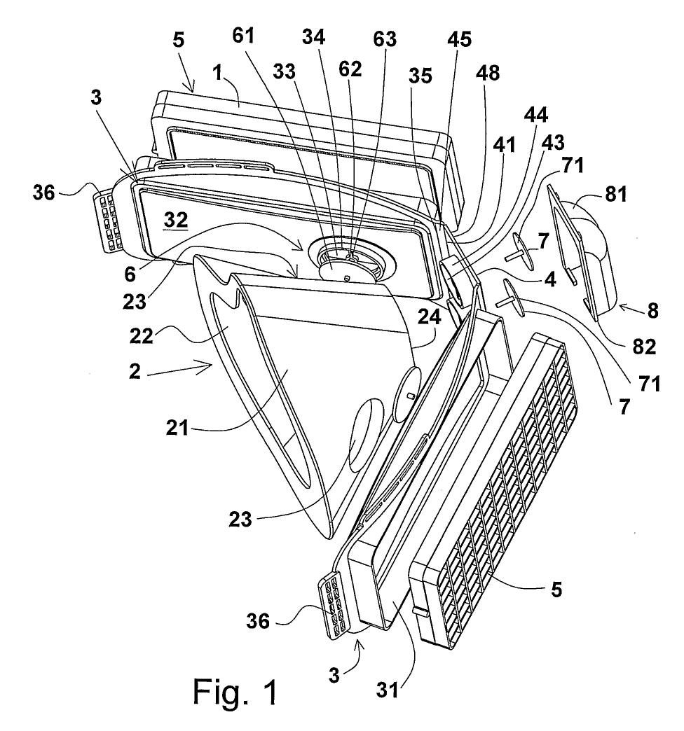

A filter section 1 and a collapsible oro-nasal mask 2 of a respirator according to a first embodiment of the present invention is shown in FIGS. 1 to 5. The filter section 1 comprises two filter supports 3 each hinged to a central support 4. The collapsible oro-nasal mask 2 is resiliently deformable.

The filter support elements 3 provide generally rectangular sockets 31 in which correspondingly shaped filters 5 are mounted. The sockets 31 are formed on the front side of each filter supports 3. The rear side of each filter supports 3 has a generally flat rear surface 32.

The walls 21 of the oro-nasal mask 2 define an inner region 22 of the oro-nasal mask 2 within which a wearer's nostrils and mouth are located, in use. The walls 21 of the oro-nasal mask 2 are contoured in order to provide a close fit, and preferably to provide a seal with, the wearer's face (in particular the wearer's nose and chin).

A circular opening 33 is provided in each filter support, to allow air to pass through each filter support, from the respective filter 5 to the oro-nasal mask 2. An inhale valve 6 is provided in each circular opening 33. Each inhale valve 6 permits air to pass from the respective filter 5 to the oro-nasal mask 2, through the circular opening 33, but not in the opposite direction. Each inhale valve 6 comprises a disc 61 that is mounted on a stalk 62. Each stalks 62 is held in the centre of the respective opening 33 by support elements 63 extending radially from the centre to the perimeter of the openings 33. Each disks 61 is located on the rear side of the respective support element 63.

Annular lips 34 protrude rearward from the rear surfaces 32 of filter supports 3, around the circumferences of the two circular openings 33. Two corresponding circular openings 23 are provided in the walls 21 of the oro-nasal mask 2. Rims of these openings 23 are fitted over the annular lips 34 to secure the oro-nasal mask 2 to the filter supports 3 and to provide a sealed path for air passing from the filters 5 into the oro-nasal mask 2.

Two circular openings 43 are provided in the central support 4 to allow air to pass from the oro-nasal mask 2 to the atmosphere external to the respirator through the central support 4. An exhale valve 7 is provided in each circular opening 43. The exhale valves 7 permit air to pass from the oro-nasal mask 2, through the circular openings 33, to the external atmosphere, but not in the opposite direction. Each exhale valve 7 comprises a disc 71 that is mounted on a stalk 72. Each stalks 72 is held in the centre of the respective opening 33 by support elements 73 extending radially from the centre to the perimeter of the opening 43. However, unlike the disks 61 of the inhale valves 6, each disk 71 is located on the front side of the respective support elements 73. It is this different positioning of the discs 61, 71 relative to the support elements 63, 73 that makes the valves appropriate for air intake and air expulsion respectively.

Annular lips 44 protrude rearward from the rear surface 45 of the central support 4, around the circumferences of the two circular openings 43. An opening 24 is provided at the front end of the oro-nasal mask 2. The rim of this opening 24 fits over both of the annular lips 44 of the central support to secure the oro-nasal mask 2 to the filter supports 3 and to provide a sealed path for air passing from the inner region of the oro-nasal mask 2 to the external atmosphere via the exhale valves 7.

The central support 4 is a rectangular panel with longest side edges 41, 42 extending vertically. First ends 35 of the filter supports 3 are hinged to the edges 41, 42 of the central support 4 by respective living hinges 45. Second ends 36 of the filter supports 3, which are opposite to the first ends 35, are free ends. The filter supports 3 can each rotate, about the respective hinges 45, relative to the central support 4. The filter supports 3, the living hinges 45 and the central support 4, are made from a single moulding.

An exhale valve cover 8 is fitted to the front surface 48 of the central support 4. The exhale valve cover 8 has a half-tube shape. The half tube is tapered at its top end 81 but is open at its bottom end 82, such that, in combination with the front surface of the central support 4, it provides an air channel that, in use, directs air that is expelled from the respirator, via the exhale valves 7, downwardly. Furthermore, the exhale valve cover 8 provides a dead space which safeguards against dynamic leakage from the exhale valves 7 during use.

The respirator has a hood (not shown in FIGS. 1 to 5) which is fixed to the filter supports 3. The hood is for fitting over the head of the wearer, in order to provide protection for the user's head against CBRN hazards. The hood has a hole at one end through which the wearer's head may enter the hood. The hole is surrounded by a ring of elastomeric material which provides a neck seal.

The respirator also has a harness (not shown in FIGS. 1 to 5) comprising a plurality of elastomeric bands which may extend around the hood to prevent the hood and oro-nasal mask from slipping in use.

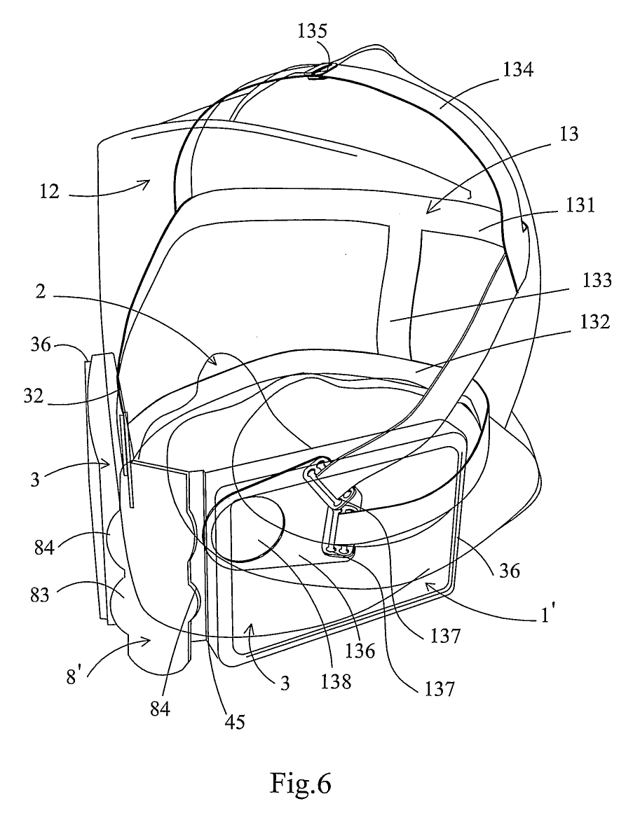

Although the hood and the harness of this first embodiment are not shown in FIGS. 1 to 5, the hood and harness may be the same or similar to the hood and harness discussed below with respect to the second embodiment (and as shown in FIGS. 6 to 9).

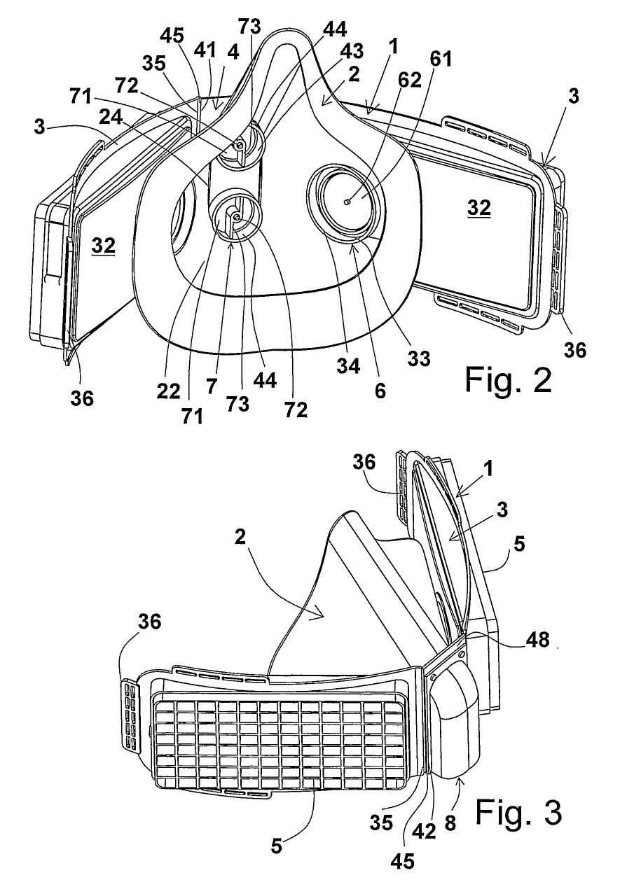

FIGS. 2, 3 and 5 show the respirator in a deployed state, i.e. a state ready for use. However, FIG. 4 shows a top view of the respirator in a storage state. In this storage state, the oro-nasal mask 2 is collapsed from its natural shape. The free ends 36 of the filter supports 3 are adjacent to one another such that the rear surfaces 32 of the filter supports 3 have generally parallel planes. In this position, the filter supports 3 press the walls of the oro-nasal mask 2, forcing the oro-nasal mask 2 into the collapsed state. In combination, the two filter supports 3 and the central support 4 provide three walls of an enclosure 9 within which the collapsed oro-nasal mask 2 is located. Other components of the respirator may be stored in the enclosure 9 such as the hood (not shown) and the harness (not shown).

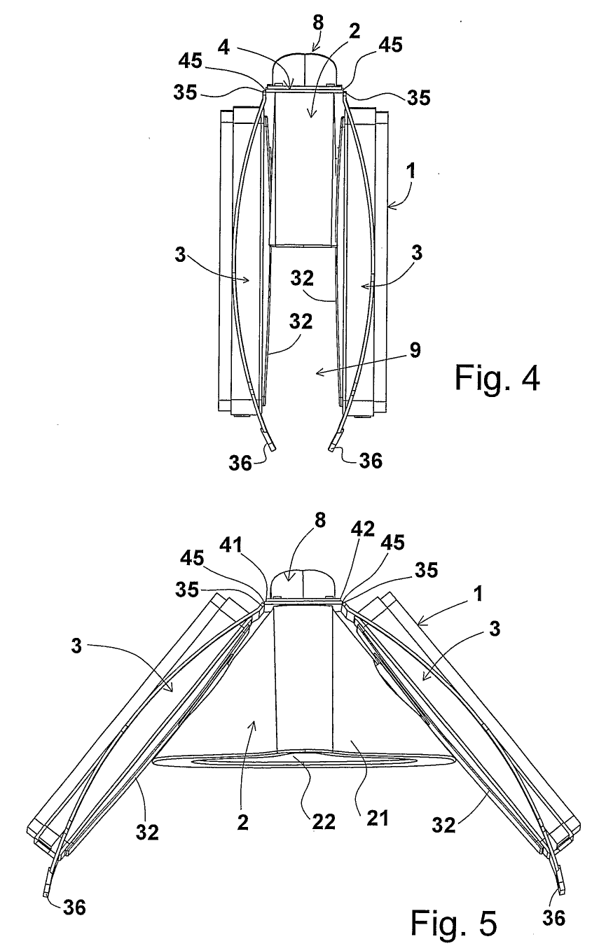

Like FIG. 4, FIG. 5 also shows a top view of the respirator. However, in FIG. 5, the oro-nasal mask 2 is in a deployed state, ready for use. Effectively, the filter supports 3 have rotated, about their respective hinges, from the positions shown in FIG. 4. The free ends 36 of the filter supports 3 have moved further apart, allowing the oro-nasal mask 2 to essentially spring into the deployed state (its natural shape) due to it being formed of resiliently deformable material.

A second embodiment of a respirator according to the present invention is shown in FIGS. 6 to 9.

FIG. 6 shows the respirator, which includes a filter section 1′, an oro-nasal mask 2, a hood 12 and a harness 13. Parts of the respirator of the second embodiment that have the same general configuration and functionality as parts of the respirator of the first embodiment have been given the same reference numbers.

The filter section 1′ is almost identical to the filter section 1 of the first embodiment, except for the exhale valve cover 8′ of filter section 1′, which has a different shape. The front face 83 of this exhale valve cover 8′ has undulated side edges 84, which allow larger exhale valves (not shown) to be used in the respirator.

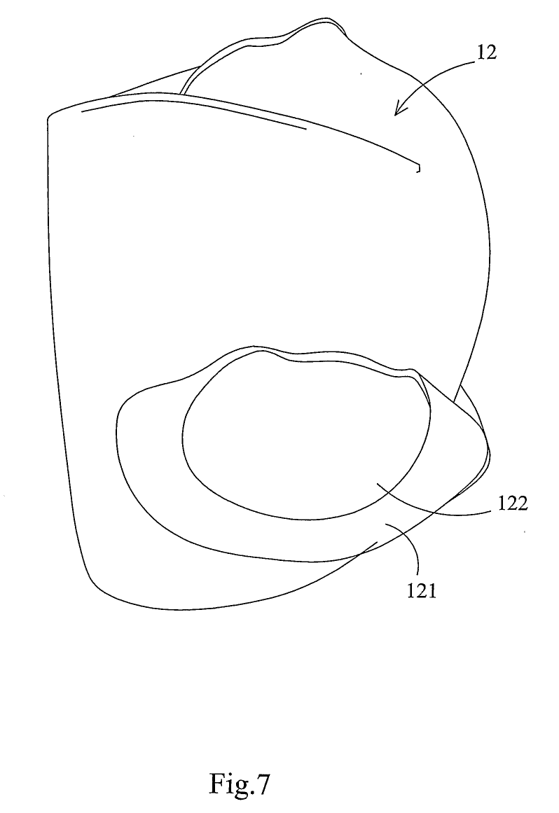

The hood 12 of the respirator can be seen best in FIG. 7. The hood 12 is of thin polyurethane material that can be folded easily, and is welded to form a self-supporting structure. Since the hood 12 can be folded easily, it may be stored in a confined enclosure defined by the filter supports 3, along with the oro-nasal mask 2 and the harness 13, when the respirator is in a storage state (in a manner as discussed with respect to the first embodiment of the present invention). The hood 12 is transparent so that a wearer may see through it.

The hood 12 includes a ring-shaped elastomeric neck seal 121, at a lower end thereof. The neck seal 121 defines the perimeter of a hole 122 through which the wearer's head may enter the hood 12. The neck seal 121 is intended to seal around the wearer's neck once the wearer's head enters fully the hood 12 during the hood donning procedure, and preventingress of e.g. toxic vapour into the hood 12 from the surrounding atmosphere. The hood 12 and neck seal 121 are sized to fit the 5-95^{th} percentile range of the population.

As can be seen in FIG. 6, the oro-nasal mask 2 is located inside the hood 12 and the filter section 1′ is located outside the hood 12. Holes (not shown) are provided in the hood 12 to permit inhalant and exhalent to flow between the filter section 1′ and the oro-nasal mask 2 via the inhale valves and exhale valves respectively. The inhale valve and exhale valves are not shown in the FIG. 6, but are similar to the inhale valves 6 and exhale valves 7 as discussed with respect to the first embodiment of the present invention. The hood 12 is welded to the rear surfaces 32 of the filter sections 3 about the perimeter of these holes. Furthermore, the hood 12 is welded to the outer edges of the rear surfaces 32 of the filter supports 3, to prevent the hood 12 and the filter section 1′ being levered apart.

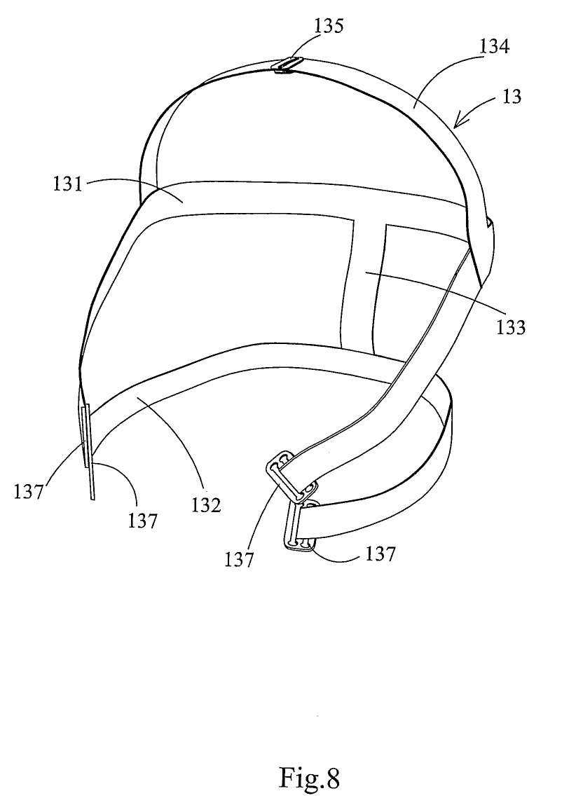

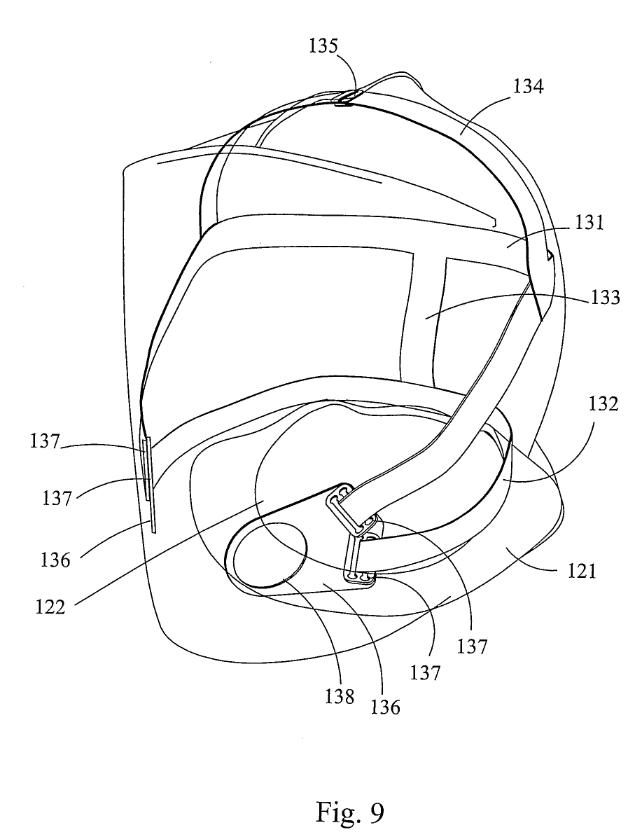

The harness 13 of the respirator can be seen best in FIG. 8. The harness 13 is intended to secure the respirator to the wearer's head, preventing slipping thereof. The harness 13 includes a plurality of elastic straps 131-134. Two main elastic straps 131, 132 are provided, which extend one above the other, in normal use, around the back of the head of the wearer. The main straps 131, 132 are spaced apart, parallel with each other, and generally horizontal, at a position adjacent that back of the wearer's head. The upper strap 131 of the two main straps 131, 132 extends above the wearer's ears, and the lower strap 132 of the two main straps 131 132 extends below the wearer's ears, in normal use.

A vertical strap 133 extends in a generally vertical direction between the two main straps 131, 132 at a position adjacent a midpoint of the back of the user's head, in normal use. Additionally, a top strap 134 extends in an arc from two points of the upper main strap 131, over the crown of the wearer's head, in normal use. The top strap 134 includes a connector 135, allowing it to be assembled easily.

Each end of the upper main strap 131 is connected to a respective end of the lower main strap 132 via a respective one of two plates 136.

As can be seen in FIGS. 6 and 9, the harness 13 is located inside the hood 12. Each of the two plates 136 is secured to the filter section 1′, as shown in FIG. 6. The securing is provided by each of the two plates 136 having a hole 138 through which conjoined portions of the oro-nasal mask 2 and the two filter supports 3 extend. Each end of the main straps 131, 132 has a connector 137 to facilitate its connection with the plate 136.

The harness 13 is sized to fit the 5-95^{th} percentile range of the population.

What is claimed is:

1. A respirator, including a collapsible air guide (2) and two filter supports (3),
each filter support (3) having a first end (35) and a second end (36) opposite to the first end (35),
the first ends (35) of the filter supports (3) being joined together, the second ends (36) being free ends,
wherein the filter supports (3) are relatively movable from a first position, in which the air guide (2) is in a collapsed state, to a second position, in which the air guide (2) is in a deployed state,
characterised in that in the first position the second ends (36) are adjacent to one another and in the second position the second ends (36) are further apart than in the first position.

2. A respirator according to claim 1, wherein the air guide (2) is located between the filter supports (3) when they are in said first position.

3. A respirator according to claim 2, wherein the air guide (2) is resilient and is adapted resiliently to deform from its collapsed state to its deployed state on movement of the filter supports (3) from the first position.

4. A respirator according to claim 1, wherein the air guide (2) is an oro-nasal mask.

5. A respirator according to claim 1 further comprising a hood (12) for fitting over the head of a wearer of the respirator, which hood (12) is connected to the filter supports (3) or to the air guide (2).

6. A respirator according to claim 5, wherein the hood (12) is located between the filter supports (3) when they are in said first position.

7. A respirator according to claim 5, wherein the hood (12) includes an elastomeric neck seal (121) adapted to seal around the neck of a wearer of the respirator.

8. A respirator according to claim 1, further comprising a harness (13) for securing the respirator to the head of a wearer of the respirator, which harness (13) is connected to the filter supports (3).

9. A respirator according to claim 8, wherein the harness (13) is located between the filter supports (3) when they are in said first position.

10. A respirator according to claim 1, wherein an inhale valve (6) is located in one of said filter supports (3), which inhale valve (6) lies in an air inhale path between a filter (5) in said filter support (3) and the air guide (2) and is arranged to prevent air passing from the air guide (2) to said filter (5) via the air inhale path.

11. A respirator according to claim 10, wherein the inhale valve (6) comprises a disc (61) mounted on a stalk (62), the stalk (62) being held in an opening (33) in the filter support (3) by support elements (63) extending from the perimeter of the opening (33).

12. A respirator according to claim 1, wherein an exhale valve (7) is located in a central support member (4) between said filter supports (3), which exhale valve (7) lies in an air exhale path between the air guide (2) and the atmosphere external to the respirator and is arranged to prevent air passing from said atmosphere to the air guide (2) via the air exhale path.

13. A respirator according to claim 12, wherein the exhale valve (7) comprises a disc (71) mounted on a stalk (72), the stalk (72) being held in a hole (43) in the central support (4) by support elements (73) extending from the perimeter of the hole (43).

14. A respirator according to claim 1, wherein each filter support (3) has a filter (5) mounted thereon, each filter (5) comprising two types of filtration media.

15. A respirator according to claim 1, wherein the filter supports (3) are formed integrally with each other.

16. A respirator according to claim 1, wherein the first ends (35) of the filter supports (3) are joined together via at least one living hinge (45).

17. A respirator according to claim 1, wherein there is a space (9) between the filter supports (3) when they are in the first position.

18. A respirator according to claim 1, wherein the air guide (2) is of silicone or polyisoprene elastomer.

19. A respirator according to claim 1 enclosed by removable external packaging.

20. A respirator according to claim 1, wherein the air guide (2) is resilient and is adapted resiliently to deform from its collapsed state to its deployed state on movement of the filter supports (3) from the first position.
